(19) United States
(12) Patent Application Publication
(10) Pub. No.: US 2022/0081269 A1
(43) Pub. Date: Mar. 17, 2022

(54) MECHANICALLY UNLOCKED AUTOMOBILE LIFTER

(71) Applicant: Yonrise Technology Co., Ltd., Yingkou City (CN)

(72) Inventor: Fengbo GAO, Yingkou City (CN)

(21) Appl. No.: 17/030,980

(22) Filed: Sep. 24, 2020

(30) Foreign Application Priority Data
Sep. 14, 2020 (CN) 202022001713.3

(51) Int. Cl. B66F 7/16; B66F 7/28

(52) U.S. Cl. CPC B66F 7/16; B66F 2700/02; B66F 7/28

(57) ABSTRACT

The invention provides a mechanically unlocked automobile lifter includes a power device, oil cylinders and lifting platform devices. The lifting platform devices include two lifting platform devices having a same structure. Each lifting platform device includes an upper table and a lower plate having a scissor-type support arm disposed therebetween. The scissor-type support arm includes first and second support arms, ends of the first support arm are respectively slidably connected with the upper table and fixedly connected with the lower plate, ends of the second support arm are respectively fixedly connected with the upper table and slidably connected with the lower plate. The lower plates have first and second beams disposed therebetween. The oil cylinders are disposed on the scissor-type support arms of the two lifting platform devices, and the power device is connected with the oil cylinders. Each lower plate is disposed with a mechanical safe locking device.

### TECHNICAL FIELD

The invention relates to the technical field of automobile maintenances, and more particularly to a new mechanically unlocked automobile lifter.

### DESCRIPTION OF RELATED ART

An automobile lifter is used to lift the automobile in the process of automobile maintenance. When the automobile is driven to a working station of the lifter, the automobile can be lifted to a certain height by manual operation, which is convenient for automobile maintenance. The lifter plays a very important role in the maintenance of automobile. Now the maintenance plants are equipped with lifters. The lifter is the necessary equipment of automobile repair plant, the lifting effect of the lifter affects its scope of application, the stability and safety of the equipment are related to the life safety of the automobile repair personnel. Therefore, there is a need for an automobile lifter with reasonable structure, convenient operation, sufficient power, safe and stable lifting, and being reliable.

In terms of safety devices, the existing automobile lifters are mainly locked and unlocked by electric or electronically controlled pneumatic unlocking. A large number of standardized electrical components are used, such as a transformer, a time relay, a rectifier bridge, an AC contactor, a limiter and circuitry, for controlling the unlocking and locking of safety locks. Due to the large number of standard electrical components, failure rates will occur, dropping of electrical components and wiring falling during transportation, and the installation and debugging of electrical components will bring high cost for after-sales and debugging. In addition, at present, a few products will have manual unlocking mode, and during the unlocking process, the operator will go under the lifter carrying the automobile to unlock the safety lock, and there will be a great security risk in the instant of unlocking. Therefore, it is needed to design a new mechanically unlocked automobile lifter.

A Chinese utility model patent application No. 201620704596.8 (publication number of which is CN205802866U), filed on Jul. 6, 2016, published on Dec. 14, 2016 and titled as “a new mechanical hydraulic automobile lifter”. The utility model discloses a new mechanical hydraulic automobile lifter including a base, a main hydraulic cylinder, a limiting device, an auxiliary hydraulic cylinder. One side of the base is disposed with a slope, a guiding frame is installed on the base, and the limiting device is arranged on the guiding frame. A lifting switch is installed on the guiding frame, the main hydraulic cylinder is installed on the base, a main support plate is arranged on the main hydraulic cylinder, two ends of the main support plate are provided with pulleys, a blocking member is installed on the main support plate, a bottom plate is arranged on the main support plate, the auxiliary hydraulic cylinder is installed on the bottom plate, a support rod is installed on the bottom plate, and an auxiliary support plate is installed on the support rod. The beneficial effects are that: simple structure, easy operation, sufficient power, safe and stable lifting, and can effectively prevent the automobile from moving.

The above patent document discloses a new mechanical hydraulic automobile lifter, but the safety performance of the automobile lifter is not high, the function is single, and the work efficiency is not high, which cannot meet people's demands for automobile lifters.

### SUMMARY

Accordingly, a primary objective of the invention is to provide a new mechanically unlocked automobile lifter with strong stability, stable operation and high efficiency, which can be controlled directly by using a hydraulic power unit, convenient to use and have high safety performance.

In order to achieve the above objective, an embodiment of the invention provides a mechanically unlocked automobile lifter including a power device, oil cylinders and lifting platform devices. The lifting platform devices include a first lifting platform device and a second lifting platform device.

Each of the first lifting platform device and the second lifting platform device includes an upper table and a lower plate. The upper table and the lower plate of each of the first lifting platform device and the second lifting platform device have a scissor-type support arm disposed therebetween. The scissor-type support arm includes a first support arm and a second support arm, the first support arm and the second support arm are arranged intersecting with each other. An upper end of the first support arm is slidably connected with the upper table, and a lower end of the first support arm is fixedly connected with the lower plate. An upper end of the second support arm is fixedly connected with the upper table, and a lower end of the second support arm is slidably connected with the lower plate. The lower plates of the first lifting platform device and the second lifting platform device have a first beam and a second beam disposed therebetween. The first beam is hinged with the lower end of the second support arm, and the second beam is hinged with the lower end of the first support arm. The oil cylinders are disposed on the scissor-type support arms of the first and second lifting platform devices. The power device is connected with the oil cylinders.

The lower plates of the first and second lifting platform devices are disposed with mechanical safe locking devices respectively.

In an embodiment, the power device includes a hydraulic power unit.

In an embodiment, each of the mechanical safe locking devices includes lock teeth and a lock frame; the lock teeth are disposed on the lower plate, an end of the lock frame is connected with the lower end of the second support arm by a shaft, and the lower end of the second support arm is disposed with an unlocking piece.

In an embodiment, the unlocking piece is an arc-shaped unlocking piece.

The technical solutions as proposed by the embodiments of the invention may have following beneficial effects that: 1) having advantages of stable operation, high safety reliability and low failure rate; 2) the safety is enhanced through the mechanical safe locking devices, the customer experience is improved, and the product reliability is further guaranteed; 3) reducing the cost, being more convenient to use and suitable for universal promotion.

### BRIEF DESCRIPTION OF THE DRAWINGS

In order to more clearly illustrate technical solutions of embodiments of the disclosure, drawings used in the description of the embodiments will be briefly described below. Apparently, the drawings described below are merely some embodiments of the disclosure, and those skilled in the art can obtain other drawings based on these drawings without creative efforts.

FIG. 1 is a schematic structural view of a mechanically unlocked automobile lifter according to an embodiment of the invention.

FIG. 2 is a schematical side view of the mechanically unlocked automobile lifter.

FIG. 3 is a schematic front view of the mechanically unlocked automobile lifter.

FIG. 4 is a schematic top view of the mechanically unlocked automobile lifter.

FIG. 5 is a schematic structural view of a mechanical safe locking device in an unlocking state of the mechanically unlocked automobile lifter according to an embodiment of the invention.

FIG. 6 is a schematic structural view of a mechanical safe locking device in an unlocking state of the mechanically unlocked automobile lifter according to another embodiment of the invention.

FIG. 7 is a schematic structural view of a mechanical safe locking device of the mechanically unlocked automobile lifter according to an embodiment of the invention.

FIG. 8 is a schematic structural view of a mechanical safe locking device in a locking state of the mechanically unlocked automobile lifter according to an embodiment of the invention.

FIG. 9 is a schematic structural view of a mechanical safe locking device in a locking state of the mechanically unlocked automobile lifter according to another embodiment of the invention.

Description of numerical references in drawings:

| Numerical reference | description |
|---|---|
| 1 | Hydraulic power unit |
| 11 | First beam |
| 12 | Oil pipeline |
| 13 | Second beam |
| 2 | Oil cylinders |
| 31 | First lifting platform device |
| 32 | Second lifting platform device |
| 4 | Mechanical safe locking device |
| 5 | Scissor-type support arm |
| 51 | first support arm |
| 52 | second support arm |
| 6 | Lock frame |
| 7 | Lock teeth |
| 8 | Unlocking piece |
| 9 | Lower plate |
| 10 | Upper table |

The realization of objective, functional features and advantages of the invention will be further described in combination with embodiments with reference to accompanying drawings.

### DETAILED DESCRIPTION OF EMBODIMENTS

The technical solutions in the embodiments of the invention will be clearly and completely described below, with reference to the accompanying drawings in the embodiments of the invention. Apparently, the described embodiments are merely some of the embodiments of the invention, not all embodiments. Based on the described embodiments of the invention, all other embodiments obtained by those skilled in the art without any creativity should belong to the protective scope of the invention.

It is noted that, in the embodiments of the invention, all directional indications (such as “upper”, “lower”, “left”, “right”, “front”, “rear”, “top”, etc.) are merely for indicating relative positional relationships and motions among various components under certain specific postures (as shown in the drawings), if the specific postures change, the directional indication will change accordingly.

In the description of the invention, unless otherwise clearly stated and limited, terms “connected”, “fixed” and so on should be understood broadly. For instance, “fixed” can be a fixed connection, a detachable connection or an integral connection; can be a mechanical connection, can also be an electrical connection; can be a direct connection, can also be an indirect connection by an intermediary, can be an internal communication of two elements or an interaction between two elements, unless otherwise clearly defined. A person skilled in the art can understand concrete meanings of the terms in the invention as per specific circumstances.

Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the invention. In addition, the technical solutions of various embodiments may be combined together, any combination must be based on the realization of ordinary skilled person in the art. When a combination of technical solutions is contradictory or unable to be realized, it should be considered that such the combination of technical solutions does not exist and is not within the protection scope of the invention.

The invention provides a new mechanically unlocked automobile lifter.

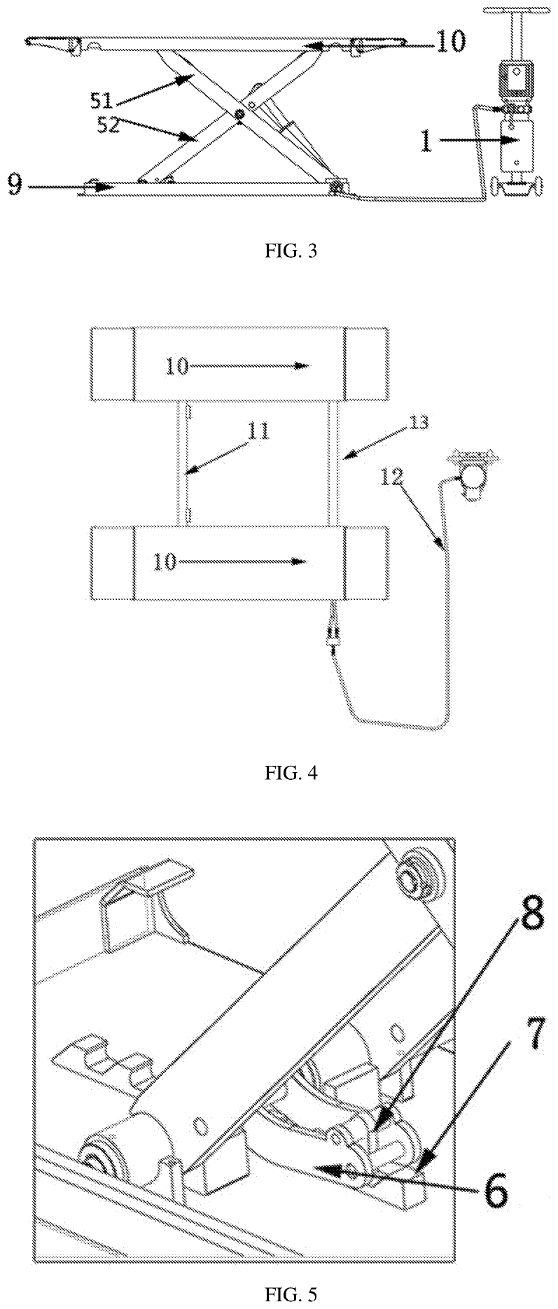

Referring to FIG. 1 through FIG. 4, in an embodiment of the invention, a mechanically unlocked includes a power device, oil cylinders 2 and lifting platform devices. The lifting platform devices includes a first lifting platform device 31 and a second lifting platform device 32. The first lifting platform device 31 and the second lifting platform device 32 are placed in parallel.

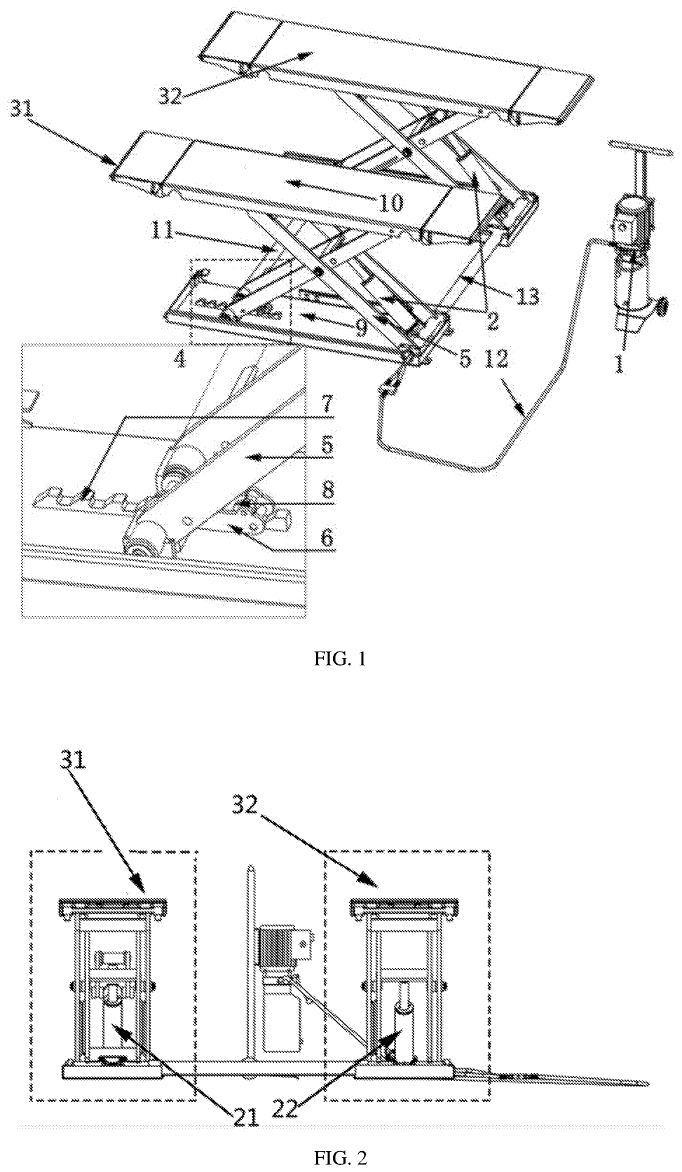

Each of the first lifting platform device 31 and the second lifting platform device 32 includes an upper table 10 and a lower plate 9. The upper table 10 and the lower plate 9 of each of the first lifting platform device 31 and the second lifting platform device 32 have a scissor-type support arm 5 disposed therebetween. The scissor-type support arm 5 includes a first support arm 51 and a second support arm 52. The first support arm 51 and the second support arm 52 are arranged intersecting with each other. An upper end of the first support arm 51 is slidably connected with the upper table 10, and a lower end of the first support arm 51 is fixedly connected with the lower plate 9. An upper end of the second support arm 52 is fixedly connected with the upper table 10, and a lower end of the second support arm 52 is slidably connected with the lower plate 9. The lower plates 9 of the first lifting platform device 31 and the second lifting platform device 32 have a first beam 11 and a second beam 13 disposed therebetween. The first beam 11 is hinged with the lower end of the second support arm 52, and the second beam 13 is hinged with the lower end of the first support arm 51. The oil cylinders 2 are disposed on the scissor-type support arms 5 of the first and second lifting platform devices 31, 32. The power device is connected with the oil cylinders 2. As shown in FIG. 2, the oil cylinders 2 includes a first oil cylinder 21 and a second oil cylinder 22.

The lower plates 9 of the first lifting platform device 31 and the second lifting platform device 32 are disposed with mechanical safe locking devices (also referred to mechanical locking devices) 4 respectively.

In the illustrated embodiment, the first lifting platform device 31 and the second lifting platform device 32 have a same structure, and preferably the power device includes a hydraulic power unit 1.

In the illustrated embodiment, the power device employs the hydraulic power unit 1 to connect the oil cylinders 2 by the oil pipeline 12 so as to provide lifting powers for the lifting platform devices. The first lifting platform device 31 and the second lifting platform device 32 adopt scissor-type structures, the first lifting platform device 31 is equipped with two support arms intersecting with each other, and the second lifting platform device 32 is also equipped with two support arms intersecting with each other.

One end of the first support arm 51 of the first lifting platform device 31 is hinged with one end of the second beam 13, and the other end of the second beam 13 is hinged with one end of the first support arm of the second lifting platform device 32. One end of the second support arm 52 of the first lifting platform device 31 is hinged with one end of the first beam 11, and the other end of the first beam 11 is hinged with the second support arm of the second lifting platform device 32.

One end of the first support arm 51 is slidable on the upper table 10, and the other end of the first support arm 51 is fixedly connected with the lower plate 9. One end of second support arm 52 is fixedly connected with the upper table 10, and the other end of the second support arm 52 is slidable on the lower plate 9.

Upper ends of the oil cylinders 2 are respectively fixed onto middle locations of the second support arms 52, and lower ends of the oil cylinders 2 are fixed onto the second beam 13 hinged with the ends of the first support arms 51. The upper ends of the oil cylinders 2 are used for applying forces onto the scissor-type support arms to make intersection angles between the first support arms 51 and the second support arms 52 be increased and two sliding points of each of the scissor-type support arms 5 slide inwardly to thereby gradually raise the lifter upwardly.

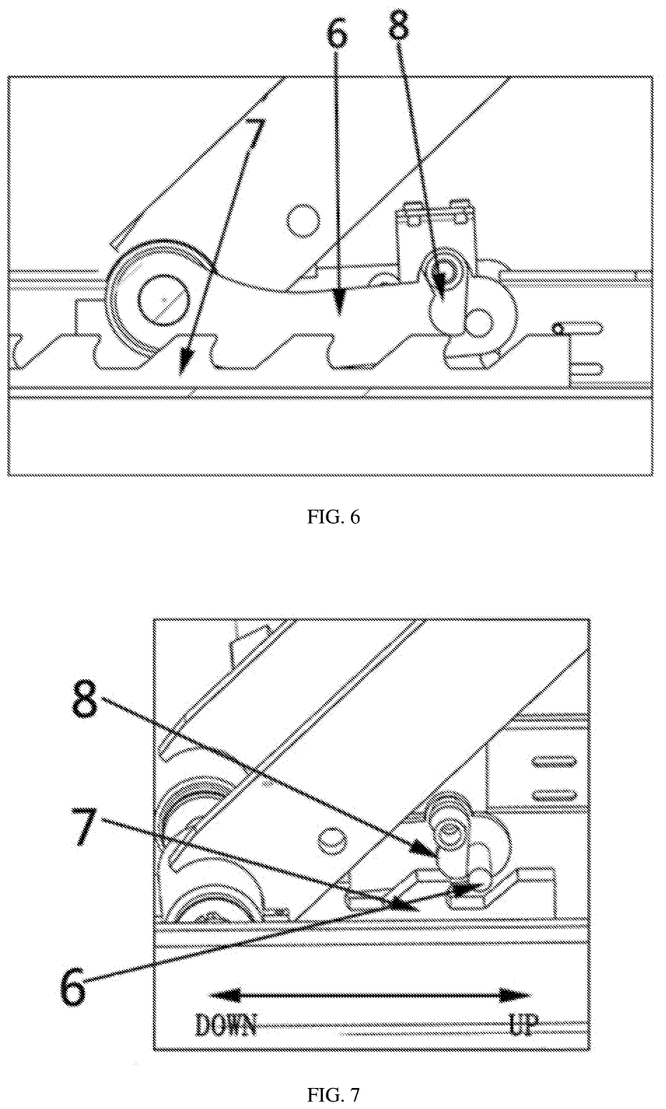

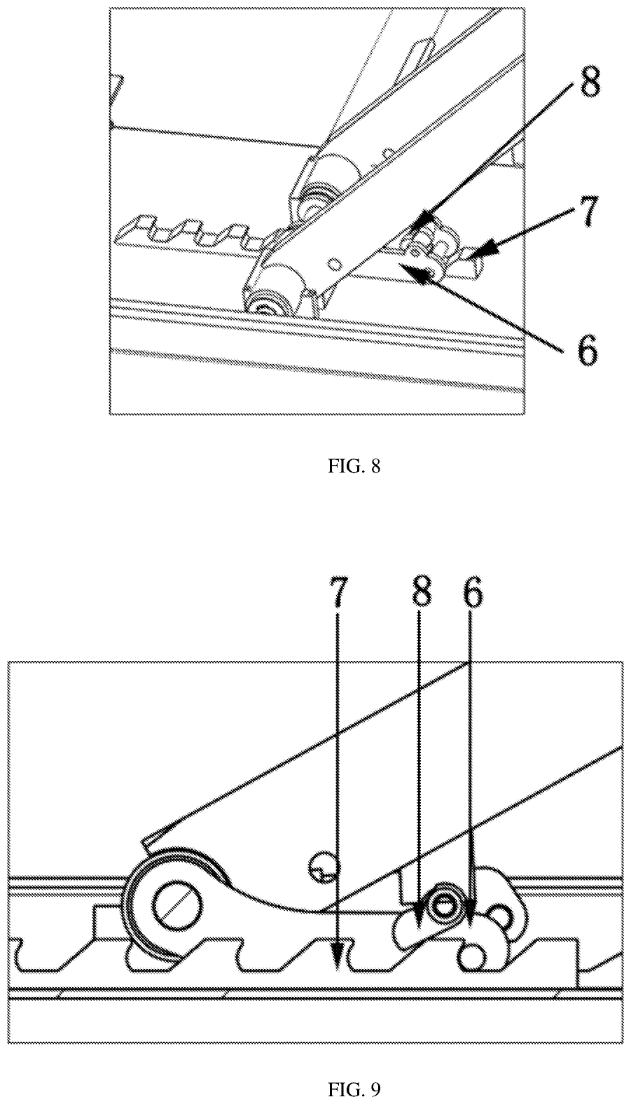

Referring to FIG. 5 through FIG. 9, in the illustrated embodiment, the mechanical safe locking device 4 includes lock teeth 7, a lock frame 6 and an unlocking piece 8. The lock teeth 7 are installed on or welded on the lower plate 9. One end of the lock frame 6 is connected with one end of the support arm 5 by a shaft, and the lock frame 6 is always above the lock teeth 7 during unlocking and locking. The unlocking piece 8 is arranged above the end of the support arm 5.

Preferably, the unlocking piece 8 is an arc-shaped unlocking piece. Of course, the unlocking piece 8 is not limited to the arc-shaped unlocking piece and may be other shaped unlocking piece.

In the illustrated embodiment of the invention, the power device uses the hydraulic power unit 1 to connect the oil cylinders 2 by the oil pipeline 12 so as to provide lifting powers for the lifting platform devices. The power device is equipped with a raise button, and the raise button is used for controlling the lifter to be raised upwardly.

At this time, the lock frame 6 will sequentially slide over convexes and concaves of the lock teeth 7. During the rising process, when the lock frame 6 falls into any one of the concaves of the lock teeth 7 and the unlocking piece 8 does not leave the convex surface, it is in a locking state. At this moment, if the lifter is stopped lifting, the lifter is in a safe locking range.

It is in locking state when a pressure relief handle of the power unit is pressed. By pressing the raise button, the lock frame 6 will reach a convex position of the lock teeth 7 along a slope of the lock teeth 7, and meanwhile the unlocking piece 8 will gradually leave the convex position and fall into the concave position of the lock teeth 7, at this time, by pressing an unloading handle of the power unit, the unlocking piece 8 of the lifter will lift the safety lock through its arc-shaped structure, so as to smoothly lower the lifter to the lowest point. It not only completes the lifting (i.e., ascending and descending) process of the scissor-type lifter, but also ensures the safety of the lifting.

On the basis of ensuring the safety and practicability of this type of lifter, compared with one electrically unlocked automobile lifter, the embodiment of the invention can save about RMB 600 yuan of electrical components, and greatly reduce the failure rate due to the reduction of the electrical components and thereby improve the customer experience. Compared with the manual unlocking mode, the safety degree is improved, the operator does not need to manually unlock under the lifter loaded with an automobile, and can judge whether the lifter has been unlocked, whether it is in the locking range by listening to the sound and visual inspection, and the product reliability is higher consequently.

The above are only preferred embodiments of the invention, and does not limit the patent protection scope of the invention. On the premise of not departing from the spirit and scope of the invention, the invention will have various modification and improvements. Under the inventive concept of the invention, equivalent structural transformations made by using the description and the attached drawings of the invention, or direct/indirect application in other related technical fields are all included in the scope of patent protection of the invention.

What is claimed is:

1. A mechanically unlocked automobile lifter comprising a power device, oil cylinders and lifting platform devices, wherein the lifting platform devices comprise a first lifting platform device and a second lifting platform device, the first lifting platform device and the lifting platform device are arranged in parallel;
wherein each of the first lifting platform device and the second lifting platform device comprises an upper table and a lower plate, the upper table and the lower plate of each of the first lifting platform device and the second lifting platform device have a scissor-type support arm disposed therebetween, the scissor-type support arm comprises a first support arm and a second support arm, the first support arm and the second support arm are arranged intersecting with each other; an upper end of the first support arm is slidably connected with the upper table, and a lower end of the first support arm is fixedly connected with the lower plate; an upper end of the second support arm is fixedly connected with the upper table, and a lower end of the second support arm is slidably connected with the lower plate; the lower plates of the first lifting platform device and the second lifting platform device have a first beam and a second beam disposed therebetween, the first beam is hinged with the lower end of the second support arm, the second beam is hinged with the lower end of the first support arm, the oil cylinders are disposed on the scissor-type support arms of the first lifting platform device and the second lifting platform device, and the power device is connected with the oil cylinders;
wherein the lower plates of the first lifting platform device and the second lifting platform device are disposed with mechanical safe locking devices respectively.

2. The mechanically unlocked automobile lifter as claimed in claim 1, wherein the power device comprises a hydraulic power unit.

3. The mechanically unlocked automobile lifter as claimed in claim 1, wherein each of the mechanical safe locking devices comprises lock teeth and a lock frame; the lock teeth are disposed on the lower plate, an end of the lock frame is connected to the lower end of the second support arm, and the lower end of the second support arm is equipped with an unlocking piece.

4. The mechanically unlocked automobile lifter as claimed in claim 3, wherein the unlocking piece is an arc-shaped unlocking piece.
